(19) United States
(12) Patent Application Publication
(10) Pub. No.: US 2006/0070524 A1
(43) Pub. Date: Apr. 6, 2006

(54) Hydrogen separation membrane and process for producing the same

(76) Inventors: Akihisa Inoue, Miyagi (JP); Hisamichi Kimura, Miyagi (JP); Shinichi Yamaura, Miyagi (JP); Motonori Nishida, Kyoto (JP); Hitoshi Okochi, Kyoto (JP); Yoichiro Shinpo, Kyoto (JP)

Correspondence Address: Hodgson russ Andrews Woods & Goodyear;Intellectual Property Practice Group, 1800 One M & T Plaza, Buffalo, NY, 14203, US

(21) Appl. No.: 10/545,263

(22) PCT Filed: Dec. 22, 2003
(86) PCT No.: PCT/JP03/16505

§ 371 Date: Aug. 10, 2005

(30) Foreign Application Priority Data
Feb. 24, 2003 (JP) 200345444

(51) Int. Cl. B01D 53/22

(52) U.S. Cl. 96/4

(57) ABSTRACT

A hydrogen permeation membrane having excellent hydrogen permeability and hydrogen embrittlement resistance, and a production method thereof. This membrane is made of a niobium alloy foil having an amorphous crystal structure, the niobium alloy foil comprising 5 to 65 atomic % of at least one member selected from the group consisting of Ni, Co and Mo as a first additive element and 0.1 to 60 atomic % of at least one member selected from the group consisting of V, Ti, Zr, Ta and Hf as a second additive element together with the balance of Nb as an indispensable constituent element wherein 0.01 to 20 atomic % of Al and/or Cu may be contained as a third additive element. This alloy foil can be produced through a method comprising preparing a metal mixture of the above formulation, heating the metal mixture to the melting point or higher in an inert gas so as to melt the same and forming the melt into a film (foil) according to a liquid quenching technique.

### TECHNICAL FIELD

The present invention relates to a metal foil (niobium alloy foil) which is useful as a hydrogen permeable membrane for a hydrogen refining unit that is utilized for fuel batteries and in semiconductor related fields, and to a production method of the metal foil.

### BACKGROUND ART

In recent years, practical application of hydrogen refining units and fuel batteries that utilize the hydrogen refining units, as well as dissemination thereof have been desired, as a measure against global warming. Such hydrogen refining units have a first and second chamber, where the first chamber is isolated from the second chamber by a membrane. Thus, when a gas that includes hydrogen flows into the first chamber, the membrane functions so as to be substantially permeable to hydrogen in such a manner that a hydrogen enriched gas is collected in the second chamber while a gas that includes impurities (such as CO and CO₂) remains in the first chamber. For this reason, so-called hydrogen permeability is required in the membrane of a hydrogen refining unit.

Conventionally, palladium alloy foils (such as Pd—Ag foils) having hydrogen absorbing properties have been utilized as such membranes. Though palladium alloy foils have excellent hydrogen permeability, palladium is relatively expensive, and alternative products made of a material that is cheaper than palladium alloy foils have been in demand.

Then, vanadium alloys and niobium alloys have been examined as alternative materials for palladium alloys (see, for example, Japanese Laid-Open Patent Publication H1 (1989)-262,924; Japanese Laid-Open Patent Publication H4 (1992)-29,728; Japanese Laid-Open Patent Publication H11 (1999)-276,866; and Japanese Laid-Open Patent Publication 2000-159,503).

However, all of the alloys that are described in the above patent documents lack rolling properties, and specific rolling conditions and repeated annealing processing will be required in order to make such alloy foils in accordance with a rolling formation method, raising the cost of production. In addition, when annealing is repeated at the time of fabrication of a foil, in some cases, elements in the foil segregate in the distribution. In addition, such work must be carried out in an inert gas atmosphere, in order to prevent oxidation of the alloy, and a large scale unit becomes necessary for carrying out a rolling process and an annealing process in an inert gas atmosphere. In addition, vanadium alloy foils and niobium alloy foils that have been formed through rolling have low ductility and lack processability and durability.

Here, in terms of a niobium alloy foil, in order to enhance resistance to hydrogen embrittlement, the addition of Ta, Co, Mo, Ni or the like has been known (see, for example, Japanese Laid-Open Patent Publication 2000-159,503), but a problem arises in the case of Ni, for example, where hydrogen permeability is significantly lowered when the ratio of Ni to niobium exceeds 10 wt % to 20 wt % at the time when a niobium alloy foil is manufactured in accordance with a cold rolling method.

Thus, an object of the present invention is to provide a niobium alloy foil which is excellent in resistance to hydrogen embrittlement, hydrogen permeability and processability, where elements in the foil can be prevented from segregating in the distribution, and which is useful as a membrane for a hydrogen refining unit, as well as a production method thereof.

The present inventors have repeatedly conducted examination in order to achieve the above described object, and as a result, found that the above described object can be achieved by providing a hydrogen separation membrane of which the main component is a non-Pd element and which is made of a niobium alloy with an amorphous crystal structure having a specific alloy composition.

In the following, the present invention is described in further detail.

### DISCLOSURE OF THE INVENTION

A hydrogen separation membrane according to the present invention is made of an amorphous niobium alloy that is formed of 5 to 65 atomic % of at least one or more types which are selected from a group consisting of Ni, Co and Mo as a first additive element, 0.1 to 60 atomic % of at least one or more types which are selected from a group consisting of V, Ti, Zr, Ta and Hf as a second additive element, and the remaining portion of Nb as an indispensable constituent element. Such a niobium alloy is excellent in resistance to hydrogen embrittlement and hydrogen permeability, and is useful as a membrane of a hydrogen refining unit.

### BRIEF DESCRIPTION OF THE DRAWINGS

FIG. 1 is a diagram showing a production unit for niobium alloy foil according to the present invention;

FIG. 2 is a diagram showing a production unit for a niobium alloy foil according to the present invention; and

FIG. 3 is a graph showing a comparison of the hydrogen permeating performance between hydrogen separation membranes gained in Examples 7 and 8 according to the present invention and hydrogen separation membranes gained in Comparison Examples 1 and 5.

### BEST MODE FOR CARRYING OUT THE INVENTION

According to the present invention, the total amount of Ni, Co and Mo as a first additive element that is mixed in a niobium alloy is 5 to 65 atomic %, preferably 10 to 50 atomic %, and more preferably, 20 to 40 atomic %, and within these ranges, the niobium alloy that includes Ni, Co and Mo exhibits excellent resistance to hydrogen embrittlement. According to the present invention, in the case where the first additive element is Ni, it is preferable for its composition ratio to be 20 to 40 atomic %.

In addition, according to the present invention, the total amount of V, Ti, Zr, Ta and Hf which are mixed in a niobium alloy as a second additive element is 0.1 to 60 atomic %, preferably, 10 to 50 atomic %, and more preferably, 20 to 40 atomic %. At least one type of these additive elements may be added to the niobium alloy within the above described ranges, and thereby, the hydrogen permeability of the gained niobium alloy foil can be increased.

Furthermore, according to the present invention, Al and/or Cu may be mixed in the niobium alloy as a third additive element, and resistance to hydrogen embrittlement can further be improved by adding such an element, and the preferable composition ratio of such a metal is 0.01 to 20 atomic %, and 0.1 wt % to 5 wt % is more preferable.

In addition to the above described additive elements, Nb is included in a hydrogen separation membrane according to the present invention, as an indispensable constituent element, and the composition ratio of Nb in the alloy is preferably 15 to 70 atomic %, and more preferably, 25 to 50 atomic %.

In addition, Nb—Ni—Zr based alloys, Nb—Ni—Zr—Al based alloys, Nb—Ni—Ti—Zr based alloys, Nb—Ni—Ti—Zr—Co based alloys, Nb—Ni—Ti—Zr—Co—Cu based alloys, Nb—Co—Zr based alloys and the like, can be exemplified as preferable Nb alloy compositions according to the present invention, but the present invention is not limited to them.

According to the present invention, a preferable ratio (atomic percent ratio) of Nb:Ni can be appropriately selected, and 1:0.8 to 1.2 is preferable, and approximately 1:1 is more preferable.

Next, a production method for a hydrogen separation membrane according to the present invention is described. According to the production method of the present invention, first, Nb, which is an indispensable constituent element, a first additive element, a second additive element, and third additive element, if necessary, are prepared in accordance with the above described composition ratio, and a metal mixture made of these component metals is heated to a temperature that is no lower than the melting point in an inert gas so as to be melted, and this melt is processed to a membrane form (foil form) using a liquid quenching method. At this time, a preferable method for processing the melt to a foil form is as follows: a crucible having a slit through the bottom is utilized to prepare melt of a niobium alloy made of the above described composition while a roll formed of a columnar body which is placed so that the center axis is parallel to the slit is rotated, the melt is jetted from the slit to the surface of the above described roll, which is rotated in such a manner that the melt that is jetted from the slit is instantaneously cooled, and then, the niobium alloy that has solidified on the surface of the roll is continuously peeled from the surface of the roll, and thus, a foil is gained.

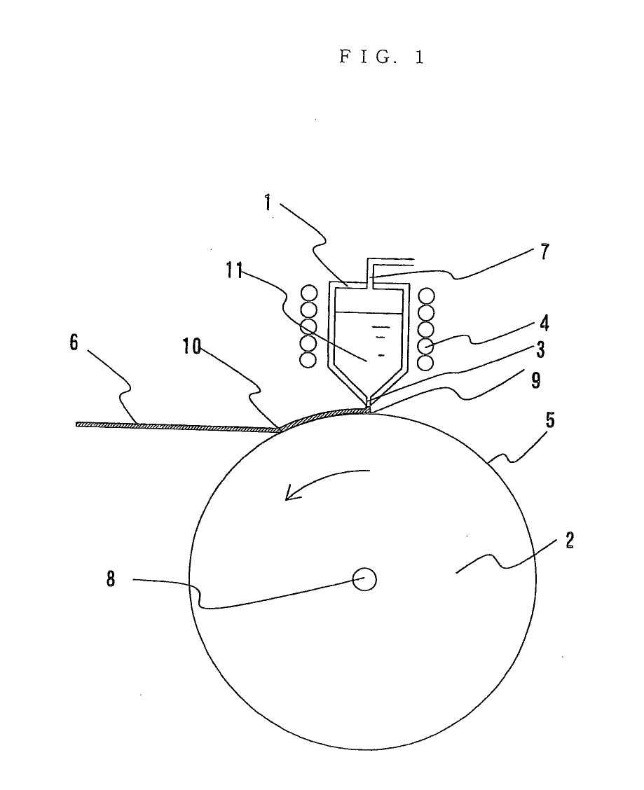

FIG. 1 shows a concrete example of a unit that is preferable for use at the time of manufacture of a hydrogen separation membrane according to the present invention; however, this unit is conceptually shown, and not limited to this.

A crucible 1 in the unit (alloy foil production unit), shown in FIG. 1, is formed of a recess and a lid, and the inside thereof can be sealed. The material of this crucible 1 is not particularly limited, as long as crucible 1 is formed of a material which can withstand high temperatures where a niobium alloy that has been placed within the recess is melted, and which does not chemically react with this melt. Boron nitride based ceramics, for example, can be exemplified as an appropriate material for crucible 1.

In addition, a heating means for heating the inside of the crucible is provided around this crucible 1. This heating means is not particularly limited, as long as it can heat the inside of the crucible to a temperature that is no lower than the melting point of the niobium alloy. The unit shown in FIG. 1 is provided with a high frequency induction heater 4 made of a high frequency coil as a heating means. This high frequency induction heater 4 allows the melt within the crucible to be mixed through circulation by convection, and thus, the niobium alloy can be rapidly melted with the temperature distribution uniformly maintained. Here, in the case where a thermocouple is placed within the crucible, the temperature of the melt of the niobium alloy within the crucible can be confirmed.

According to the present invention, crucible 1 is provided with a gas inlet 7. Thus, when the niobium alloy that has been placed within the crucible is completely melted, a gas may be injected through this inlet 7, so that a pressure can be applied on the inside of the crucible.

The gas that is injected from this inlet 7 is inert, and thus, oxidation of the melted niobium alloy is prevented. Nitrogen, helium, argon and hydrogen, for example, can be exemplified as particularly appropriate inert gases, and from among these, an argon gas is particularly preferable.

Here, though the pressure within the crucible at the time when a gas has been injected into the crucible is not particularly limited, it is preferable for the pressure within the crucible to be 0.01 MPa to 0.1 MPa.

According to the present invention, a slit 3 is provided in the bottom of the crucible. Slit 3 allows the melt within the crucible to be sprayed toward surface 5 of the below described roll 2 that is rotating. This slit is usually closed when the niobium alloy that has been placed within the crucible has not completely melted. A means for closing this slit is not particularly limited. Here, according to the present invention, it is not necessary for the slit to be provided in a portion that protrudes in nozzle form from the bottom of the crucible, as shown in FIG. 1.

Though the width of slit 3 is not particularly limited, it is preferable for the slit to have a width of 0.1 mm to 0.6 mm, more preferable for it to be 0.2 mm to 0.5 mm, and most preferable for it to be 0.3 mm to 0.4 mm. As a result of this, a foil having a desired thickness can be gained. Meanwhile, the length of slit 3 is also not particularly limited, and the length of the slit in the design can be appropriately changed in accordance with the dimensions of the roll.

As shown in FIG. 1, according to the present invention, roll 2, which is a columnar body, is placed beneath the slit. This roll 2 is placed so that the center axis 8 becomes parallel to slit 3 of the crucible, and the roll is attached so as to rotate around this center axis 8 at the center. Thus, the melt 11 that has been jetted form slit 3 is sprayed toward surface 5 of the roll that is rotating. Namely, the melt that has been jetted from the slit makes contact with the surface of the roll at a first point 9 on the surface of the roll, and is instantaneously cooled, so as to form a foil layer on the surface of the roll. The roll is rotating at a constant rotational speed, and the foil layer is continuously peeled at a second point 10, and thus, a foil 6 is gained. The foil that has been peeled is collected within a chamber (not shown).

Here, according to the present invention, the relative positional relationship between slit 3 and roll 2 are not particularly limited, as long as slit 3 and the center axis of the roll are parallel to each other, and the surface of the roll is positioned in the direction of the jet coming from the slit.

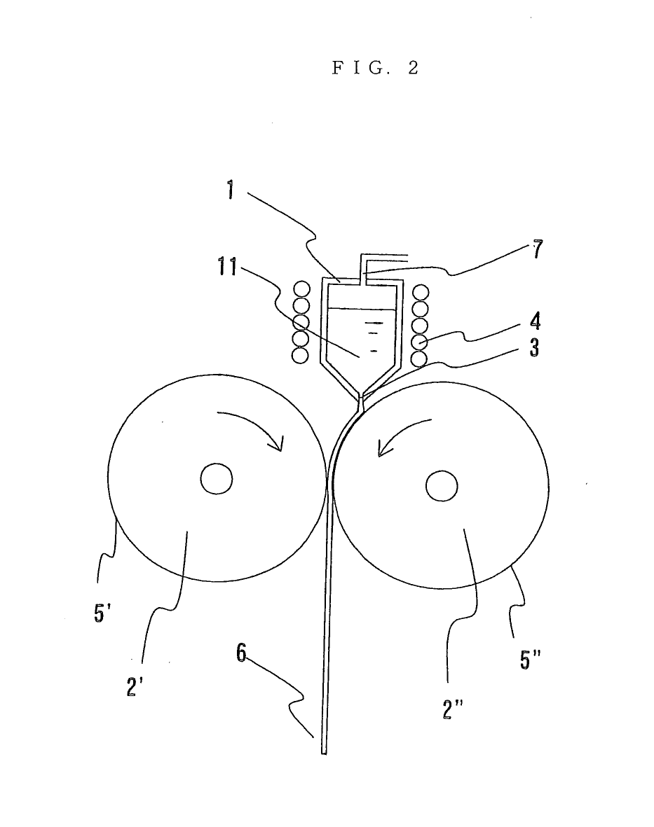

Here, the present invention is not limited to a case where a unit formed of one roll 2 (single roll type unit) is utilized, as shown in FIG. 1, but rather, a unit with two rolls 5′ and 5″ (double roll type unit) may be used, as shown in FIG. 2.

In the case of the unit shown in FIG. 2, a first roll 2′ is placed so as to be parallel to a second roll 2″, and first roll 2′ and second roll 2″ rotate inwardly in the downward direction. Thus, when the melt within the crucible is jetted toward the space between the first roll and the second roll from slit 3, this melt makes contact with either or both of first roll 2′ and second roll 2″ so as to be rapidly cooled, and thereby, a foil layer is formed on surfaces 5′ and 5″ of the rolls. Then, the foil layer that has been formed on the surfaces of the rolls is continuously peeled, and thus, a foil is gained.

According to the present invention, it is necessary for rolls 2, 2′ and 2″ to rapidly cool the melt that has been jetted from slit 3, and therefore, it is necessary for them to be formed of a material having high heat conductance, such as copper. Here, a hole through which a cooling liquid, such as water, passes may be created inside the rolls.

In addition, according to the present invention, it is necessary for surface 5 of the roll to be continuous. In addition, the surface of the roll has sufficient smoothness, so that a foil layer that has been formed on the surface of the roll can be easily peeled.

According to the present invention, though the rotational speed of roll 2 is not particularly limited, it is preferable for roll 2 to be rotated so that surface 5 of the roll moves at 450 m/min to 3000 m/min. As a result of this, the melt that has been jetted from the slit can be rapidly cooled, and an excellent foil having an amorphous crystal structure can be fabricated.

According to the present invention, the amount of melt that is jetted, the width of the slit, the rotational speed of the roll(s) and the like may be adjusted, and thereby, the thickness of the niobium alloy foil to be gained can be freely changed. According to the present invention, though the thickness of the gained niobium alloy foil is not particularly limited, in the Examples, it is 5 μm to 1000 μm. In particular, in the case where the thickness of the niobium alloy foil that is gained according to the present invention is 5 μm to 40 μm, the niobium alloy that forms this foil becomes amorphous. A foil of an amorphous niobium alloy is particularly useful as the membrane of a hydrogen refining unit.

According to the present invention, a unit that includes a crucible and a roll are placed in an inert gas, such as argon, and thereby, oxidation of the niobium alloy foil to be gained can be prevented.

### EXAMPLES

A foil of a niobium alloy was fabricated utilizing a single roll type alloy foil production unit having the structure illustrated in FIG. 1.

Crucible 1 was made of boron nitride based ceramics, and had a slit having a width of 0.4 mm and a length of 30 mm. Roll 2 was made of copper and had the dimensions: diameter of 300 mm and length of 80 mm. The distance between surface 5 of the roll and slit 3 was 0.5 mm. The roll was cooled with water. The number of rotations of the roll was set at 1500 rpm. A niobium alloy of 50 Nb-40 Ni-10 Zr (atomic %) was placed within the crucible. The inside of the crucible was heated to 1750° C., and the niobium alloy was completely melted. After that, an argon gas was injected into the crucible so that the melt was jetted from the slit so as to form a foil layer on the surface of the roll, and this foil layer was continuously peeled from the roll, so as to gain a niobium alloy foil (Example 1) having a thickness of 0.03 mm. The pressure within the crucible was 0.05 MPa.

In addition, in the same manner, alloy foils according to Examples 2 to 19 of the present invention were fabricated so as to have alloy compositions as shown in Table 1 below.

Meanwhile, as comparison examples, alloy foils were fabricated according to Comparison Examples 1 to 8, so as to have alloy compositions as shown in Table 2 below.

TABLE 1
Examples

| | | Composition | Composition (atomic %) | | | |
|---|---|---|---|---|---|---|
| No. | Base | (atomic %) | Nb | Additive 1 | Additive 2 | Additive 3 |
| 1 | Nb—Ni—Zr | Nb₅₀Ni₄₀Zr₁₀ | 50 | Ni: 40 | Zr: 10 | |
| 2 | | Nb₄₅Ni₄₅Zr₁₀ | 45 | Ni: 45 | Zr: 10 | |
| 3 | | Nb₄₀Ni₄₀Zr₂₀ | 40 | Ni: 40 | Zr: 20 | |
| 4 | | Nb₃₅Ni₃₅Zr₃₀ | 35 | Ni: 35 | Zr: 30 | |
| 5 | | Nb₃₀Ni₃₀Zr₄₀ | 30 | Ni: 30 | Zr: 40 | |
| 6 | | Nb₃₂Ni₄₈Zr₂₀ | 32 | Ni: 48 | Zr: 20 | |
| 7 | | Nb₂₈Ni₄₂Zr₃₀ | 28 | Ni: 42 | Zr: 30 | |
| 8 | | Nb₂₄Ni₃₆Zr₄₀ | 24 | Ni: 36 | Zr: 40 | |
| 9 | | Nb₂₀Ni₃₀Zr₅₀ | 20 | Ni: 30 | Zr: 50 | |
| 10 | | Nb₂₀Ni₆₀Zr₂₀ | 20 | Ni: 60 | Zr: 20 | |
| 11 | | Nb₂₅Ni₆₅Zr₁₀ | 25 | Ni: 65 | Zr: 10 | |
| 12 | Nb—Ni—Zr—Al | Nb₁₈Ni₅₄Zr₁₈Al₁₀ | 18 | Ni: 54 | Zr: 18 | Al: 10 |
| 13 | Nb—Ni—Ti—Zr | Nb₂₀Ni₆₀Ti₁₅Zr₅ | 20 | Ni: 60 | Ti: 15, Zr: 5 | |
| 14 | | Nb₂₆Ni₃₉Ti₅Zr₃₀ | 26 | Ni: 39 | Ti: 5, Zr: 30 | |
| 15 | | Nb₃₂Ni₄₈Ti₁₀Zr₁₀ | 32 | Ni: 48 | Ti: 10, Zr: 10 | |
| 16 | Nb—Ni—Ti—Zr—Co | Nb₂₀Ni₅₅Ti₁₅Zr₅Co₅ | 20 | Ni: 55, Co: 5 | Ti: 15, Zr: 5 | |
| 17 | Nb—Ni—Ti—Zr—Co—Cu | Nb₂₀Ni₅₃Ti₁₀Zr₈Co₆Cu₃ | 20 | Ni: 53, Co: 6 | Ti: 10, Zr: 8 | Cu: 3 |
| 18 | Nb—Co—Zr | Nb₄₅Co₄₅Zr₁₀ | 45 | Co: 45 | Zr: 10 | |
| 19 | | Nb₃₀Co₃₅Zr₃₅ | 30 | Co: 35 | Zr: 35 | |

TABLE 2
Comparison Examples

| | | Composition | Composition (atomic %) | | | |
|---|---|---|---|---|---|---|
| No. | Base | (atomic %) | Nb | Additive 1 | Additive 2 | Additive 3 |
| 1 | Nb—Ni | Nb₄₀Ni₆₀ | 40 | Ni: 60 | | |
| 2 | | Nb₇₀Ni₃₀ | 70 | Ni: 30 | | |
| 3 | Nb—Co | Nb₆₀Co₄₀ | 60 | Ni: 40 | | |
| 4 | | Nb₈₅Co₁₅ | 85 | Ni: 15 | | |
| 5 | Nb—Ni—Zr | Nb₁₀Ni₈₀Zr₁₀ | 10 | Ni: 80 | Zr: 10 | |
| 6 | Nb—Ni—V | Nb₁₅Ni₁₅V₇₀ | 15 | Ni: 15 | V: 70 | |
| 7 | Nb—Ni—Zr—Al | Nb₁₄Ni₄₂Zr₁₄Al₃₀ | 14 | Ni: 42 | Zr: 14 | Al: 30 |
| 8 | Nb—Ni—V—X | Nb₁₅Ni₁₅V₃₀Zr₄₀ | 15 | Ni: 15 | V: 30, Xr: 40 | |

Thus, evaluation of properties in terms of the following evaluation items was carried out in accordance with the following measurement method on the alloy foils according to Examples 1 to 19 and the alloy foils according to Comparison Examples 1 to 8, which were gained as described above.

Surface state; observed with a microscope, and smoothness of the surface was evaluated.

Existence of pinholes; a liquid dye where an oil soluble red dye is dissolved in a solvent so as to have a concentration of 1 g/L was prepared, while a sample was placed on a blotting paper in a drafty location that was sufficiently ventilated, and the liquid dye was applied onto the sample with a brush. The sample was removed after five minutes had elapsed, and whether or not dyed spots were formed on the blotting paper was confirmed.

Existence of segregation in the distribution of elements in the foil; existence of segregation in the distribution of elements in the foil was checked by means of EPMA (electron microprobe analysis).

Crystal structure; the crystal structure was analyzed in accordance with an x-ray diffraction method.

Hydrogen permeating performance; the respective alloy foils according to Examples 7 and 8, as well as Comparison Examples 1 and 5, were fixed to a gas permeation measuring cell and heated to 400° C., and a hydrogen gas was made to flow on one side thereof, and thus, the amount of flow of the hydrogen gas that permeated through the foil was measured on the opposite side.

As a result, it was found that all of the alloy foils according to Examples 1 to 19 which were gained as described above had a uniform thickness, and an excellent surface state where no pinholes were confirmed. Moreover, there was no segregation in the distribution of elements in the alloy foils, and the crystal structure thereof was amorphous, providing excellent hydrogen permeability and resistance to hydrogen embrittlement, and thus, it was confirmed that the foils could be useful as the membrane of a hydrogen refining unit.

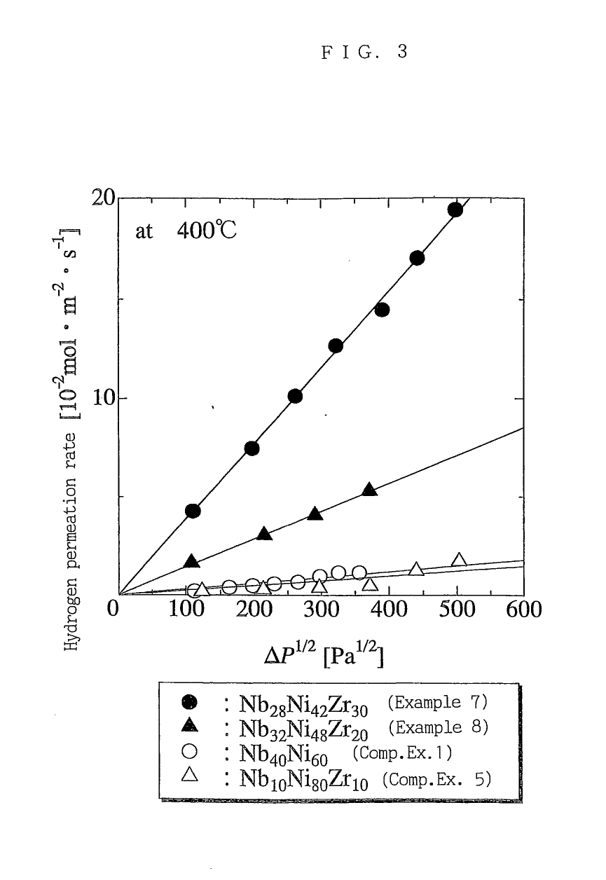

In contrast, the alloy foils according to Comparison Examples 1 to 8 were as follows: in the case of Comparison Examples 6 and 8, bands of amorphous foil were failed to be made, and therefore, the alloy foils could not be gained; in the case of Comparison Examples 4 and 7, though the foils were gained, they were not amorphous; in the case of Comparison Examples 1, 2, 3 and 5, though excellent bands of amorphous foil were gained, the amount of hydrogen that permeated through was significantly low (see FIG. 3).

In addition, it was found from the graph of hydrogen permeating performance of the alloy foils according to Examples 7 and 8, as well as according to Comparison Examples 1 and 5, shown in FIG. 3, that the hydrogen permeable membranes according to the present invention have a hydrogen permeating performance that is significantly superior to that of the alloy foils according to Comparison Examples 1 and 5, such that Nb28Ni42Zr30 (Example 7) exhibits a hydrogen permeating coefficient as high as 1.3×10⁻⁸ [mol·m⁻¹·sec⁻¹·Pa^{-1/2}], and Nb32Ni48Zr20 (Example 8) exhibits a hydrogen permeating coefficient as high as 6.4×10⁻⁹ [mol·m⁻¹·sec⁻¹·Pa^{-1/2}], respectively, at a measurement temperature of 400° C.

### INDUSTRIAL APPLICABILITY

A hydrogen permeable membrane having an amorphous crystal structure according to the present invention has performance such that only hydrogen permeates with high efficiency, and has sufficient toughness and stability in a hydrogen atmosphere, and therefore, is particularly useful as the hydrogen permeable membrane of a hydrogen refining unit which is utilized for fuel batteries and in semiconductor related fields.

In addition, according to a production method of the present invention, a niobium alloy foil having a composition that makes it difficult to be processed in accordance with a conventional rolling method can be manufactured relatively easily, and thereby, a hydrogen permeable membrane for a hydrogen refining unit which does not cause reduction in the hydrogen permeability and which is excellent in resistance to hydrogen embrittlement can be obtained, even if it has such a composition which causes a reduction in the hydrogen permeability in the case where the membrane having the same composition is made in accordance with the conventional rolling method (for example, a composition where the ratio of Ni to Nb exceeds 20 wt %).

1. A hydrogen separation membrane, characterized by being made of a niobium alloy having an amorphous crystal structure.

2. The hydrogen separation membrane according to claim 1, wherein the niobium alloy is made of 5 to 65 atomic % of at least one or more types selected from a group consisting of Ni, Co and Mo as a first additive element, 0.1 to 60 atomic % of at least one or more types selected from a group consisting of V, Ti, Zr, Ta and Hf as a second additive element, and the remaining portion of Nb, which is an indispensable constituent element.

3. The hydrogen separation membrane according to claim 2, wherein the niobium alloy further contains 0.01 to 20 atomic % of Al and/or Cu as a third additive element.

4. A production method for a hydrogen separation membrane made of an amorphous niobium alloy, characterized in that a metal mixture gained by mixing 5 to 65 atomic % of at least one or more types selected from a group consisting of Ni, Co and Mo as a first additive element, 0.1 to 60 atomic % of at least one or more types selected from a group consisting of V, Ti, Zr, Ta and Hf as a second additive element, and a remaining portion of Nb, which is an indispensable constituent element, is heated to a temperature that is no lower than the melting point in an inert gas so as to be melted, and processed to a film form using a liquid quenching method.

5. The method for production a hydrogen separation membrane according to claim 4, wherein 0.01 to 20 atomic % of Al and/or Cu is additionally mixed into the metal mixture as a third additive element.
